(19) United States
(12) Patent Application Publication
(10) Pub. No.: US 2020/0194753 A1
(43) Pub. Date: Jun. 18, 2020

(54) POWER STORAGE DEVICE

(71) Applicant: Panasonic Intellectual Property Management Co., Ltd., Osaka (JP)

(72) Inventors: Isao Fujiwara, Osaka (JP); Yoshitaka Shinyashiki, Hyogo (JP)

(73) Assignee: Panasonic Intellectual Property Management Co., Ltd., Osaka (JP)

(21) Appl. No.: 16/718,910

(22) Filed: Dec. 18, 2019

Related U.S. Application Data
(63) Continuation of application No. PCT/JP2018/020689, filed on May 30, 2018.

(30) Foreign Application Priority Data
Jun. 26, 2017 (JP) 2017-124136

(51) Int. Cl. H01M 2/10; H01M 2/02; H01M 2/14; H01M 10/48

(52) U.S. Cl. CPC H01M 2/1077; H01M 10/48; H01M 2/14; H01M 2/025

(57) ABSTRACT

Provided is a power storage device comprising: a battery stack in which a plurality of secondary batteries and a plurality of spacers are alternately arranged; a pair of end plates disposed on both sides in the first direction of the battery stack; and a compression spring serving as a pressurizing means for pressurizing the battery stack. Each of the secondary batteries includes an electrode body and an outer case. The outer case has a projection that swells towards the inside so as to press the electrode body in the first direction and deforms with expansion of the electrode body.

### TECHNICAL FIELD

The present disclosure relates to a power storage device.

### BACKGROUND ART

Conventionally, there is widely known a power storage device comprising a battery laminate formed by arraying a plurality of flat shaped secondary batteries (rectangular batteries). For example, Patent Literature 1 discloses a vehicular power storage device comprising a pair of end plates disposed on facing surfaces of a battery laminate, and configured to pressurize rectangular batteries in the laminating direction, and a bind bar connected to the upper and lower end plates and fixing the end plates with a certain interval therebetween. An electrode assembly of a secondary battery is expanded with time due to deterioration of the battery, and therefore in the power storage device disclosed in Patent Literature 1, pressure applied to the electrode assembly is increased with time.

### CITATION LIST

### Patent Literature

PATENT LITERATURE 1: Japanese Unexamined Patent Application Publication No. 2015-187911

### SUMMARY

While it is important to keep an interval between electrodes composing the electrode assembly constant by applying predetermined pressure to the electrode assembly, the expansion of the electrode assembly is preferably allowed to a certain degree so as not to inhibit battery reaction, in order to prevent damage or the like of the power storage device. That is, it is an important subject to allow the expansion of the electrode assembly while uniformly maintaining the electrode interval.

A power storage device of one aspect of the present disclosure comprises: a battery laminate formed by alternately arraying a plurality of secondary batteries and a plurality of spacers; a pair of end plates provided on both sides in a first direction of the battery laminate, the first direction being a direction in which the secondary batteries and the spacers are arranged; and a pressurizing unit for pressurizing the battery laminate, the pressurizing unit being provided between at least one of the pair of end plates, and the battery laminate, wherein each of the secondary batteries comprises: an electrode assembly; and an exterior body that houses the electrode assembly, and has a protrusion which swells inward to press the electrode assembly in the first direction, and which deforms with expansion of the electrode assembly.

According to the aspect of the present disclosure, there may be provided a power storage device capable of uniformly maintaining an interval between electrodes composing each electrode assembly while allowing expansion of the electrode assemblies accompanied with deterioration of batteries over the end of life from an initial stage state of the secondary batteries. According to the power storage device of the aspect of the present disclosure, breaking of the device resulting from the expansion of the electrode assemblies may be prevented, and battery performance such as discharge capacity may be satisfactorily maintained.

### BRIEF DESCRIPTION OF DRAWING

FIG. 1 is a perspective view of a power storage device as an example of an embodiment.

FIG. 2 is a sectional view taken along a line AA in FIG. 1.

FIG. 3 is a diagram illustrating a state of the power storage device at an initial stage of charge/discharge cycles.

FIG. 4 is a diagram illustrating a state of the power storage device after predetermined charge/discharge cycles.

FIG. 5 is a diagram illustrating a power storage device as another example of the embodiment.

### DESCRIPTION OF EMBODIMENTS

Hereinafter, an example of an embodiment will be described in detail with reference to the drawings. However, a power storage device of the present disclosure is not limited to the embodiment described below. The drawings referred for the description of the embodiment are schematically illustrated, and the dimension ratios and the like of components drawn in the drawings should be determined in consideration of the description below. When “substantially parallel” is described as an example, the “substantially . . . ” in this specification intends to include not only a complete parallel state but also a parallel state recognized as a substantially parallel state.

Hereinafter, a plurality of secondary batteries composing a battery laminate are electrically connected. However, the respective secondary batteries may not be electrically connected, only some of the plurality of secondary batteries may be electrically connected to each other. That is, the plurality of secondary batteries composing the single battery laminate may be connected to a power source individually or per predetermined block, so as to enable charge and discharge.

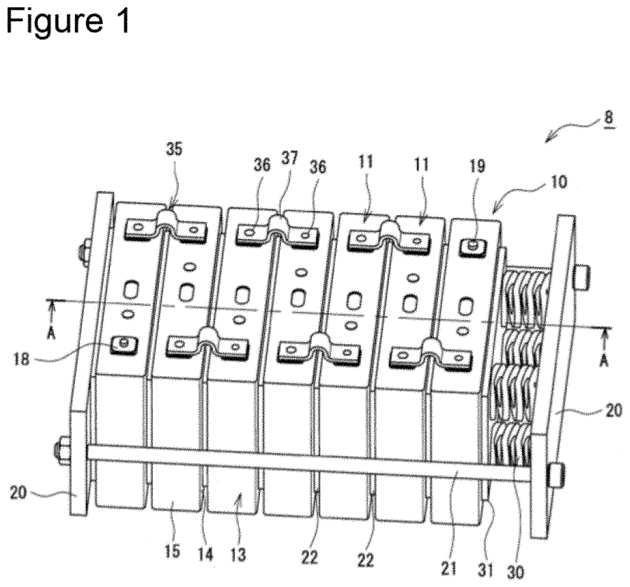

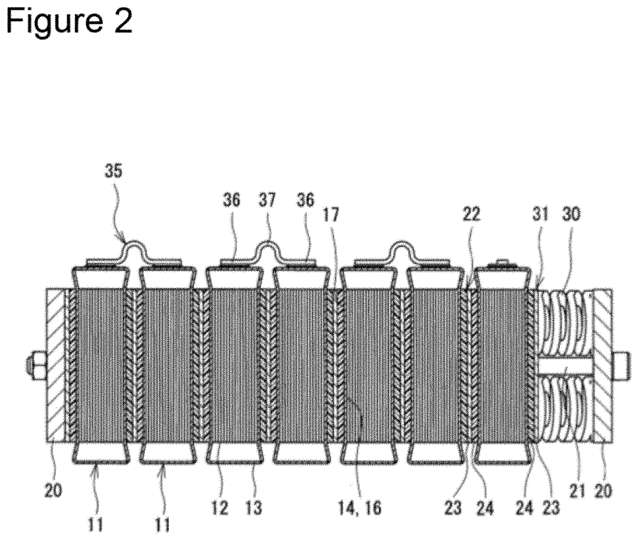

FIG. 1 is a perspective view of a power storage device 8 as an example of the embodiment, and FIG. 2 is a sectional view taken along the line AA in FIG. 1. In this embodiment, a plurality of secondary batteries 11 and a plurality of spacers 22 composing a battery laminate 10 are arranged horizontally. In this specification, the direction in which the secondary batteries 11 and the spacers 22 are arranged is defined as a “first direction”. The direction orthogonal to the first direction in the horizontal direction is defined as a “second direction”, and the direction orthogonal to the first and second directions is defined as a “vertical direction”.

As illustrated in FIG. 1 and FIG. 2, the power storage device 8 comprises the battery laminate 10 formed by alternately arraying the plurality of secondary batteries 11 and the plurality of spacers 22. The power storage device 8 comprises a pair of end plates 20 provided on both sides in the first direction of the battery laminate 10, and compression springs 30 serving as a pressurizing unit for pressurizing the battery laminate 10. The compression springs 30 are provided between at least one of the pair of end plates 20 and the battery laminate 10. In this embodiment, the compression springs 30 are installed between the one end plate 20 and the battery laminate 10.

The power storage device 8 is an assembled battery composed by electrically connecting the plurality of secondary batteries 11, and is called a battery module or a battery pack. In this embodiment, all the secondary batteries 11 composing the battery laminate 10 are electrically connected. As the secondary batteries 11, batteries different in capacity, dimension, type, or the like may be used, but the same batteries are preferably used. Examples of each secondary battery 11 includes a non-aqueous electrolyte secondary battery such as a lithium ion battery. In the example illustrated in FIG. 1, the battery laminate 10 is composed of the seven secondary batteries 11. However, the number of the secondary batteries 11 is not particularly limited.

The power storage device 8 comprises bind bars 21 connected to the end plates 20 such that predetermined fastening pressure acts on the battery laminate 10 by the pair of end plates 20. The end plates 20 each are a plate-like body slightly shorter in the vertical direction and slightly longer in the second direction than the secondary batteries 11, and hold the battery laminate 10 from both sides in the first direction. Each end plate 20 may be longer in the vertical direction than the secondary batteries 11. The bind bars 21 are rod-like members provided along the first direction, for example. The bind bars 21 are provided on the respective both sides in the second direction of the battery laminate 10, for example.

In this embodiment, the two bind bars 21 are mounted over the pair of end plates 20. That is, the pair of end plates 20 are connected by the two bind bars 21. Specifically, respective first ends of the bind bars 21 are fastened to one of the end plates 20, respective second ends of the bind bars 21 are fastened to the other end plate 20, and the predetermined fastening pressure acts on the battery laminate 10 by the end plates 20. Fastening power of the bind bars 21 to the end plates 20 is adjusted, so that the fastening pressure can be changed.

Each of the secondary batteries 11 composing the battery laminate 10 comprises an electrode assembly 12, and an exterior body 13 housing the electrode assembly 12. An electrolytic solution is housed in the exterior body 13. A solid electrolyte using gel polymer or the like may be used in place of the electrolytic solution. The exterior body 13 has protrusions 16 that swell inward to press the electrode assembly 12 in the first direction, and deforms with expansion of the electrode assembly 12. The protrusions 16 are formed in respective side wall parts 14 of the exterior body 13.

The secondary batteries 11 have respective positive electrode terminals 18 electrically connected to positive electrodes of the electrode assemblies 12, and respective negative electrode terminals 19 electrically connected to negative electrodes of the electrode assemblies 12. Each positive electrode terminal 18 is provided on a first end side in the second direction of an upper surface part of the exterior body 13, and each negative electrode terminal 19 is provided on a second end side in the second direction of the upper surface part of the exterior body 13. The battery laminate 10 comprises a plurality of conductive members 35 connecting the electrode terminals of the adjacent secondary batteries 11. In this embodiment, the secondary batteries 11 are arrayed such that positions of the positive electrode terminals 18 and the negative electrode terminals 19 of the adjacent secondary batteries 11 are opposite to each other, and the adjacent secondary batteries 11 are connected in series by the conductive members 35. While the details will be described below, the conductive members 35 have extension parts 37 that extend and contract in the first direction.

Each electrode assembly 12 is a laminate type electrode assembly obtained by alternately laminating a plurality of the positive electrodes and a plurality of negative electrodes in the first direction with the separators interposed therebetween. Each negative electrode is typically a size larger than the positive electrode, and a mixture layer of each negative electrode is disposed so as to face at a portion where a mixture layer of the positive electrode is formed. In the electrode assembly 12, a plurality of separators may be used, a single separator obtained by being folded a plurality of times may be used. A laminate structure of the electrode assembly 12 is maintained by being pressed in the first direction by the protrusions 16 of the exterior bodies 13, for example. The electrode assembly may be a wound type electrode assembly obtained by winding the positive electrodes and the negative electrodes with separators interposed therebetween.

Each exterior body 13 is, for example, a rectangular metal case composed of a bottomed cylindrical case body, and a sealing plate that seals an opening of the case body. That is, each secondary battery 11 is a so-called rectangular battery. The case body of the exterior body 13 has the two side wall parts 14 disposed so as to face each other, and two side wall parts 15 disposed so as to face each other, and a bottom surface part. The four side wall parts are formed substantially perpendicular to the bottom surface part, for example. The upper surface part of the exterior body 13 is formed by the sealing plate.

In this embodiment, each side wall part 14 is disposed substantially parallel to the positive electrode and the negative electrode composing the electrode assembly 12, and each side wall part 15 is disposed along the first direction. Each side wall part 14 is disposed substantially parallel to the end plates 20. Therefore, the above fastening pressure that acts on the battery laminate 10 by the pair of end plates 20 acts on the side wall parts 14 of each secondary battery 11.

The side wall parts 14 are formed larger than the side wall parts 15. The area of each side wall part 14 is formed larger than the area of the positive electrode and the negative electrode composing the electrode assembly 12. Each side wall part 15 is formed longer than the thickness of the electrode assembly 12 in the first direction. For example, the side wall part 14 has a substantially rectangular shape longer in the second direction than the vertical direction, and the side wall parts 15 has a substantially rectangular shape longer in the vertical direction than the first direction. In this embodiment, only the side wall parts 14 among the side wall parts 14, 15 deform with the expansion of each electrode assembly 12.

The protrusions 16 are formed on the two side wall parts 14 disposed so as to face each other, respectively, and press and hold the electrode assembly 12 from the both sides in the first direction. Consequently, movement of the electrode assembly 12 in the exterior body 13 can be restricted, and the laminate structure of the electrode assembly 12 can be maintained. The electrode assembly 12 is preferably housed in the exterior body 13 in a state in which the end of each electrode is not in contact with an inner surface of the exterior body 13. In this case, clearances exist between the electrodes, and the side wall parts 15 and the bottom surface part, and it is possible to prevent damage of the electrode assembly 12 caused by pressing of the ends of the electrodes against inner surfaces of the side wall parts 15 or the like, and bending the ends of the electrodes.

The protrusions 16 are formed by pressing the side wall parts 14 from outside. Therefore, on outer surfaces of the side wall parts 14, recesses 17 are formed at positions corresponding to the protrusions 16. The protrusions 16 and the recesses 17 are formed by, for example, inserting the electrode assembly 12 into the case body of the exterior body 13, and thereafter bringing the ends of the electrodes into non-contact states with the side wall parts 15 and the bottom surface part as much as possible, or bringing the ends of the electrodes into complete non-contact states, and pressing the side wall parts 14 from outside. An interval between the side wall parts 14 before forming the protrusions 16 is larger than the thickness of the electrode assembly 12, and clearances between the electrode assembly 12 and the side wall parts 14 exist. However, the protrusions 16 are formed, so that the clearances are eliminated, and the electrode assembly 12 can be pressed.

The protrusions 16 are formed at central parts of the side wall parts 14, and are preferably formed in wide ranges of the side wall parts 14. The protrusions 16 may be formed in portions other than peripheral edges of the side wall parts 14, and may be formed in the substantially whole side wall parts 14. In this embodiment, the side wall parts 14 gradually project inward from boundary positions with the side wall parts 15, and the wide ranges except the peripheral edges of the side wall parts 14 are formed substantially flat to be substantially parallel to the end plates 20. In this case, it can be said that the protrusions 16 are formed in the substantially whole regions of the side wall parts 14. The protrusions 16 may abut on whole regions of both end surfaces in the first direction of the electrode assembly 12, for example.

The protrusions 16 are formed so as to have such swell lengths that the above clearances between each electrode assembly 12 and the side wall parts 14 are eliminated, and the predetermined pressure is applied to the electrode assembly 12. The predetermined pressure only needs to be able to uniformly maintain the interval between electrodes of the electrode assembly 12 in an initial stage state of the secondary battery 11. When the electrode assembly 12 repeats charge and discharge, the electrode assembly 12 expands with time, and the protrusions 16 deforms with the expansion of the electrode assembly 12. Therefore, the electrode assembly 12 can be held at substantially constant pressure over the end of life from the initial stage state of each secondary battery 11. The protrusions 16 are pressed through the spacers 22 and the like by the compression springs 30. The protrusions 16 themselves preferably elastically deform to a certain degree with change of the volume of each electrode assembly 12.

The spacers 22 may abut on the recesses 17 formed on the side wall parts 14 of the secondary batteries 11, and deform following the deformation of the recesses 17 while pressing the recesses 17. The spacers 22 are disposed between the secondary batteries 11, and the above fastening pressure by the pair of end plates 20, and the pressure by the compression springs 30 are transmitted to the side wall parts 14 of the secondary batteries 11 through the spacers 22. The protrusions 16 are formed inside the recesses 17, and therefore the pressure acts on the electrode assemblies 12 through the protrusions 16.

The spacers 22 preferably abut on wide ranges of substantially flat portions of the recesses 17 of the secondary batteries 11. In this case, the whole electrode assemblies 12 are easily uniformly pressed. The spacers 22 may abut on the whole substantially flat portions. While the secondary batteries 11 can maintain the structures of the electrode assemblies 12 by the functions of the protrusions 16, the spacers 22 that abut on the recesses 17 exist, so that the electrode assemblies 12 can be more stably held.

Each spacer 22 preferably has a core material 23 having rigidity, and elastic members 24 that are mounted on the core material and abut on the recesses 17 of the secondary batteries 11. The spacer 22 may be composed of, for example, only the elastic members 24. However, the core material 23 having rigidity is used, so that the shape of the spacer 22 is stabilized, and more uniform pressing force easily acts on each secondary battery 11. Each spacer 22 has the elastic members 24 on both surfaces of the core material 23.

The core material 23 is composed of a plate-like resin material having a rigidity enough to substantially resist deforming by the expansion of the secondary batteries 11, for example. Each elastic member 24 is preferably composed of a more flexible member than the core material 23, and is composed of, for example, a member that elastically deforms with change of the volume of the secondary battery 11. The elastic member 24 may be formed of rubber, a foamed body, a thermoplastic elastomer, or the like, and specific examples include silicone rubber, fluororubber, ethylene-propylene rubber. The thickness of each elastic member 24 may be larger than the depth of the recess 17, the elastic members 24 may be fitted in the recesses 17 of the secondary batteries 11, and abut on substantially whole innermost portions formed in the substantially flat portions of the recesses 17.

As described above, the compression springs 30 are installed between the one end plate 20 and the battery laminate 10. The compression springs 30 extend and contract following the change of the thickness with charge and discharge of the secondary batteries 11. The compression springs 30 are provided, so that predetermined pressing force can be applied to the electrode assemblies 12 while allowing the expansion of the electrode assemblies 12, and the interval between the electrodes composing the electrode assemblies 12 can be uniformly maintained. The number of the compression springs 30 may be one. In this embodiment, the two compression springs 30 are aligned in the second direction in an upper part of the end plate 20, the two compression springs 30 are aligned in the second direction in a lower part of the end plate 20, the four compression springs 30 in total, are provided.

The compression springs 30 preferably apply pressure to the secondary batteries 11 through a pressing plate 31. The compression springs 30 may directly press the side wall parts 14 of the secondary batteries 11, and the pressing plate 31 is preferably disposed at a portion on which the compression springs 30 of the battery laminate 10 abut. The pressing plate 31 is disposed, so that the pressure of the compression springs 30 easily uniformly acts on the secondary batteries 11. The pressing plate 31 is composed of, for example, the core material 23 and the elastic member 24 similarly to the spacers 22. However, the elastic member 24 is provided only on one surface of the core material 23 (surface which abuts on the recess 17 of the secondary battery 11), and is not provided on a surface on which the compression springs 30 abut.

The compression springs 30 are, for example, compression coil springs, and are mounted on the end plate 20 such that the axial direction is along the first direction. A fixing structure of the compression springs 30 to the end plate 20 is not particularly limited. The compression springs 30 each may have a first end fixed to the end plate 20, and a second end fixed to the pressing plate 31. In a case in which a plurality of the compression springs 30 are provided, these preferably have the same shape, dimensions, strength (spring constant).

The compression springs 30 preferably pressurize the battery laminate 10 at constant pressure when the thickness change in the first direction of the secondary batteries 11 is less than 5%. Hereinafter, unless otherwise mentioned, the thickness of each secondary battery 11 is the length in the first direction of the secondary battery 11, and means the thickness of the center of the side wall part 14. The thickness of the secondary battery 11 increases with the charge/discharge cycles, and the degree of the increase is generally less than 5% with respect to the thickness at the initial stage. Therefore, when the increase of the thickness of each secondary battery 11 is less than 5%, the compression springs 30 capable of pressing each secondary battery 11 at constant pressure are used, so that intervals between the electrodes composing the electrode assemblies 12 can be efficiently kept constant over the end of life from the initial stage state of the secondary batteries 11.

For example, when the increase of the thickness of each secondary battery 11 is 5% with respect to the initial stage state, the compression springs 30 press the laminate such that the thickness of the battery laminate 10 is not increased any more. As each compression spring 30, a spring that takes a compressed limit dimension when the thickness of each secondary battery 11 increases by 5% may be used. In an example of a preferable configuration, the compression springs 30 contract following the thickness change when the increase of the thickness of each secondary battery 11 is less than 5%, while the thickness of the battery laminate 10 is restrained to a constant dimension when the thickness of each secondary battery 11 increases by 5%.

The compressed limit dimensions of the compression springs 30 are preferably changed in accordance with the type of the secondary batteries 11, specifically, in accordance with the increase ratio of the thicknesses of the secondary batteries 11. For example, in a case in which the increase of the thickness of each secondary battery 11 is large, the compression springs 30 having large compressed limit dimensions are used, and in a case in which the increase of the thickness is small, the compression springs 30 having small compressed limit dimensions are used. The compression springs 30 may pressurize the battery laminate 10 at constant pressure only in a range in which the increase of the thickness of each secondary battery 11 is less than 3%, or less than 2%.

In this embodiment, the compression springs 30 may contract with the increase of the thickness of each secondary battery 11, and the elastic members 24 of the spacers 22 may be compressed as described above. In this case, expansion of each secondary battery 11 is absorbed by the compression springs 30 and the elastic members 24, and predetermined pressing force is maintained. The elastic member 24 may be compressed more easily than the compression springs 30, and may be unlikely to be compressed. In the latter case, after a compression limit of the compression springs 30 is exceeded, the elastic members 24 are compressed, so that the expansion of each secondary battery 11 may be absorbed.

The power storage device 8 comprises the compression springs 30 as a pressurizing unit for pressurizing the battery laminate 10. However, at least one selected from, for example, a spring, a linear motion device, and a rubber member can be applied as the pressurizing unit, and both the spring and the linear motion device may be used. The linear motion device is a device that linearly drives, and examples of the linear motion device include cylinder devices such as an air cylinder, an oil hydraulic cylinder, a hydraulic cylinder, and a servo cylinder. The linear motion device may be an electric linear motion device or a motor-power linear motion device. The rubber member may be formed of rubber that elastically deforms following the change of the thickness of the battery laminate 10, and may be formed of a material similar to rubber applied to each of the elastic members 24 of the spacers 22. The rubber member is, for example, a member having a thickness larger than that of the spacer 22 and having a long extension and contraction length.

As described above, the power storage device 8 comprises the conductive members 35 electrically connecting the electrode terminals of the adjacent secondary batteries 11. In this embodiment, each plate-like conductive member 35 is installed across the positive electrode terminal 18 of one of the adjacent secondary batteries 11, and the negative electrode terminal 19 of the other secondary battery 11. However, each conductive member may connect the electrode terminals of the three or more secondary batteries 11 in parallel, or may connect the electrode terminals of all the secondary batteries 11 composing the battery laminate 10 in parallel.

Each conductive member 35 is a plate-like conductive member shorter than the thickness of the two secondary batteries 11, and has connecting parts 36 fixed to the electrode terminals, and the extension part 37 that extends and contracts in the first direction. Each conductive member 35 has a substantially constant width, and is installed such that the longitudinal direction is along the first direction. The plate-like connecting parts 36 are formed on both sides in the longitudinal direction of each conductive member 35, and the extension part 37 is formed between the two connecting parts 36.

Each extension part 37 is a bent part obtained by bending the central part in the longitudinal direction of the conductive member 35 in the thickness direction, and expands upward. When the thicknesses of the secondary batteries 11 are increased, the extension parts 37 extend in the first direction, and the lengths in the vertical direction are shortened. It can be said that each extension part 37 is a portion formed by bending the conductive member 35, and an extending and contracting property is improved as the length in the vertical direction is generally increased by largely bending. The extension parts 37 are provided, so that the expansion of the secondary batteries 11 can be allowed, and it is possible to prevent breakage or the like of the conductive members 35 resulting from the expansion of the secondary batteries 11.

The plurality of secondary batteries 11 may be able to be charged and discharged individually or per predetermined block, as described above. In this case, the power storage device comprises a conductive member for a power source (not illustrated) for connecting a power source to plurality of secondary batteries 11 individually, or the plurality of secondary batteries 11 on a per predetermined block basis. The conductive member for a power source preferably has a movable part with respect to the first direction. For example, the movable part is a bent part that is bent by bending each conductive member, similarly to the extension part 37, and the expansion of the secondary batteries 11 can be allowed by extending the movable part. In the plurality of secondary batteries 11 composing the predetermined block, the electrode terminals are preferably connected in series.

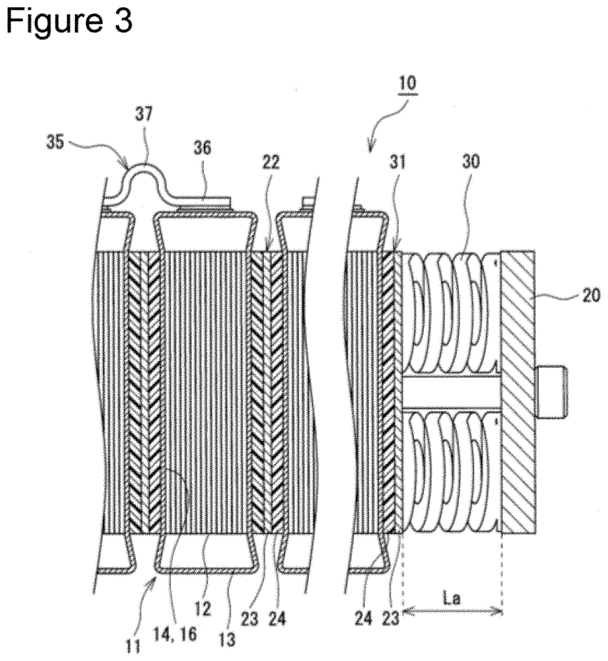

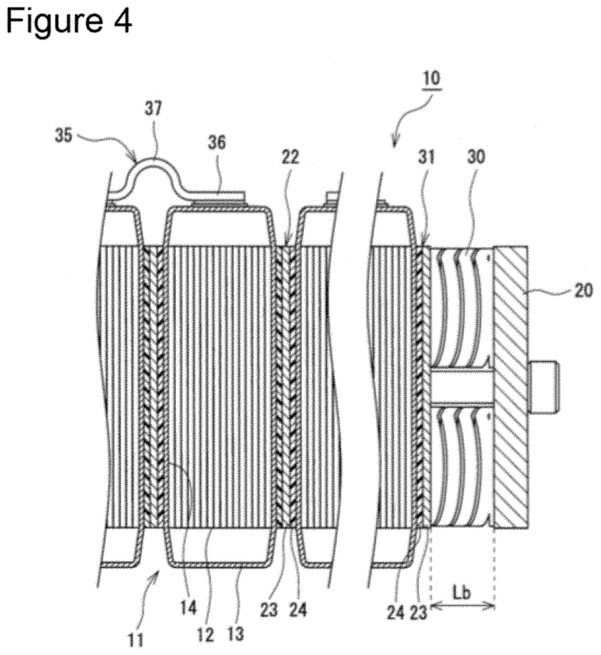

FIG. 3 is a sectional view illustrating a state of the power storage device 8 at the initial stage of the charge/discharge cycles. On the other hand, FIG. 4 is a sectional view illustrating a state of the power storage device 8 at the end of life of the secondary batteries 11 after the predetermined charge/discharge cycles, for examples. As illustrated in FIG. 3, in the initial stage state of the charge/discharge cycles, each secondary battery 11 is not expanded, and the compression spring 30 has a length La. That is, an interval between the pressing plate 31 of the battery laminate 10 and the end plate 20 becomes La.

As illustrated in FIG. 4, at the end of life of the secondary batteries 11, the electrode assemblies 12 expand in the first direction, the respective side wall parts 14 of the exterior bodies 13 pressed by the electrode assemblies 12 deform to expand outward, and the thicknesses of the secondary batteries 11 are increased. In the example illustrated in FIG.

4, the protrusions 16 and the recesses 17 of the secondary battery 11 are eliminated, and the whole of the side wall parts 14 is substantially flat, or slightly expands outward. The protrusions 16 and the recesses 17 can be formed so as to exist at the end of life of the secondary batteries 11.

When the thicknesses of the secondary batteries 11 are increased, the compression springs 30 are compressed, and the interval between the pressing plate 31 and the end plate 20 is narrowed. In the example illustrated in FIG. 4, the interval (length of the compression springs 30) is denoted by Lb. The interval between the end plates 20 is not changed. That is, the increase of the thickness of the battery laminate 10 resulting from the expansion of the secondary batteries 11 is absorbed by the compression springs 30 between the pair of end plates 20. The compression springs 30 allow the increase of the thickness of the battery laminate 10, and apply constant pressure to the battery laminate 10 to uniformly maintain the intervals between the electrodes of the electrode assemblies 12. When the thicknesses of the secondary batteries 11 are increased, the elastic members 24 of the spacers 22 are compressed, and the thicknesses of the elastic members 24 may be thinned.

As described above, in the power storage device 8, in the initial stage state of the secondary batteries 11, the electrode assemblies 12 are held from both sides in the first direction by the protrusions 16, and the electrode assemblies 12 are housed in the exterior bodies 13 in a state in which the ends of the electrodes are not in contact with the side wall parts 15 and the like. The fastening pressure by the pair of end plates 20 acts on the electrode assembly 12 through the spacers 22, the compression springs 30, and the like. When the side wall parts 14 gradually expand outward by the expansion of the electrode assemblies 12 with time, the compression springs 30 contract following the deformation. That is, the battery laminate 10 is movable in the first direction. Furthermore, the elastic members 24 of the spacers 22 may be elastically deformed. Thus, in the power storage device 8, while the expansion of the electrode assemblies 12 accompanied with the deterioration of the secondary batteries 11 is allowed over the end of life from the initial stage state of the secondary batteries 11, the predetermined pressing force is applied to the electrode assembly 12, and the intervals between the electrodes can be uniformly maintained.

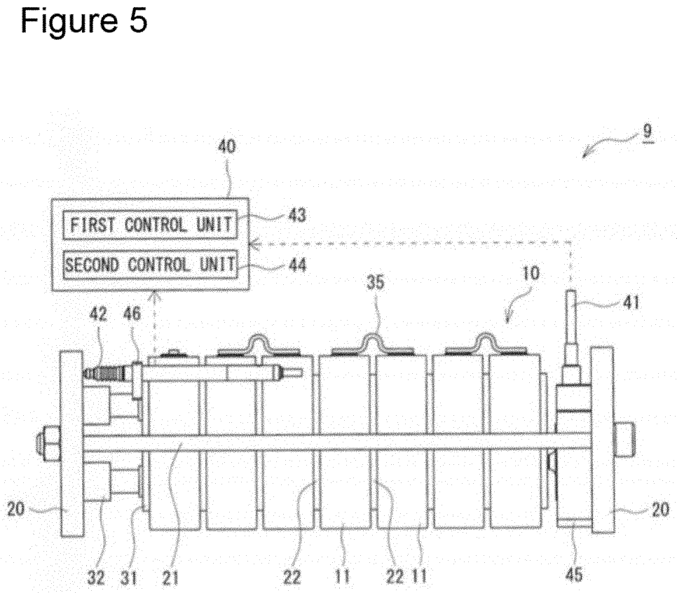

FIG. 5 is a diagram illustrating a power storage device 9 as another example of the embodiment. Herein, differences from the aforementioned embodiment will be described, components similar to those of the power storage device 8 are denoted by the same reference numerals, and overlapped description will be omitted. The power storage device 9 illustrated in FIG. 5 is different from the power storage device 8 in that the power storage device 9 comprises a pressure sensor 41 that detects pressure acting on secondary batteries 11 in the first direction. Furthermore, the power storage device 9 comprises a displacement sensor 42 that detects thickness change in the first direction of the secondary batteries 11. The power storage device may comprise only one of the pressure sensor 41 and the displacement sensor 42.

The power storage device 9 comprises cylinder devices 32 as a pressurizing unit provided between a battery laminate 10 and one of end plates 20. An electronically controllable servo cylinder is preferably used as each cylinder device 32. A plurality of the cylinder devices 32 may be provided. In the example illustrated in FIG. 5, the two cylinder devices 32 are installed. The cylinder devices 32 are mounted on, for example, the end plates 20, and press a pressing plate 31 of a battery laminate 10. The power storage device 9 comprises a controller 40 that performs predetermined control on the basis of detection information of the pressure sensor 41 and detection information of the displacement sensor 42.

A block-shaped pressure sensor holder 45 is disposed between the battery laminate 10 and the other end plate 20 in the power storage device 9, and the pressure sensor 41 is housed in the holder. A load cell can be used as the pressure sensor 41. The displacement sensor 42 is installed on the one end plate 20 side where the cylinder devices 32 are installed. In the power storage device 9, a displacement sensor supporting part 46 for fixing the displacement sensor 42 in the vicinity of the cylinder devices 32 is provided. The displacement sensor supporting part 46 may be integrally formed with, for example, the pressing plate 31. A differential transformer type sensor can be used as the displacement sensor 42. The displacement sensor 42 is disposed on a lateral side of the battery laminate 10 in a state in which a rod of the sensor abuts on the one end plate 20.

The controller 40 may perform at least one of first control of adjusting pressure applied by the cylinder devices 32 on the basis of the detection information of the pressure sensor 41, and second control of outputting information for changing a charging and discharging condition of the secondary batteries 11. Additionally, the controller 40 may perform at least one of the first control and the second control on the basis of the detection information of the displacement sensor 42. The controller 40 has a first control unit 43 for performing the first control on the basis of the detection information of at least one of the pressure sensor 41 and the displacement sensor 42, and a second control unit 44 for performing the second control on the basis of the detection information of at least one of the pressure sensor 41 and the displacement sensor 42, for example.

The first control unit 43 may adjust the extension lengths of piston rods of the cylinder devices 32 on the basis of the detection information of at least one of the pressure sensor 41 and the displacement sensor 42. The first control unit 43 shortens the extension lengths of the piston rods such that pressure detected by the pressure sensor 41 becomes constant, for example. The extension lengths of the piston rods may be shortened in accordance with a displacement amount detected by the displacement sensor 42.

The second control unit 44 may forcibly stop charge and discharge of the secondary batteries 11 on the basis of the detection information of at least one of the pressure sensor 41 and the displacement sensor 42. For example, when a detection value of each sensor exceeds a predetermined threshold value that regulates the life of the secondary batteries 11, the second control unit 44 may output, to a surveillance monitor or the like of the power storage device 9, a fact that the secondary batteries 11 reach the end of life as information for stopping the charge and discharge of the secondary batteries 11.

The second control unit 44 may control charge and discharge in accordance with the life of the secondary batteries 11. As the end of life approaches, the voltage of the secondary batteries 11 during charging is likely to increase, for example. For example, in a case in which the voltage of the secondary batteries 11 detected by the power storage device 8 becomes a predetermined threshold value or more, the second control unit 44 may perform charging such that the voltage of the secondary batteries 11 becomes the threshold value or less, or may perform charging at a predetermined charging current value or less, in subsequent charge and discharge.

### REFERENCE SIGNS LIST

8, 9 power storage device
10 battery laminate
11 secondary battery
12 electrode assembly
13 exterior body
15 side wall part
16 protrusion
17 recess
18 positive electrode terminal
19 negative electrode terminal
20 end plate
21 bind bar
22 spacer
23 core material
24 elastic member
30 compression spring
31 pressing plate
32 cylinder device
35 conductive member
36 connecting part
37 extension part
40 controller
41 pressure sensor
42 displacement sensor
43 first control unit
44 second control unit
45 pressure sensor holder
46 displacement sensor supporting part

1. A power storage device comprising:
a battery laminate formed by alternately arraying a plurality of secondary batteries and a plurality of spacers;
a pair of end plates provided on both sides in a first direction of the battery laminate, the first direction being a direction in which the secondary batteries and the spacers are arranged; and
a pressurizing unit for pressurizing the battery laminate, the pressurizing unit being provided between at least one of the pair of end plates, and the battery laminate, wherein
each of the secondary batteries comprises:
an electrode assembly; and
an exterior body that houses the electrode assembly, and has a protrusion which swells inward to press the electrode assembly in the first direction, and which deforms with expansion of the electrode assembly.

2. The power storage device according to claim 1, wherein
the pressurizing unit pressurizes the battery laminate at constant pressure, when thickness change in the first direction of the secondary batteries is less than 5%.

3. The power storage device according to claim 1, wherein
the pressurizing unit is at least one selected from a spring, a linear motion device, and a rubber member.

4. The power storage device according to claim 1, further comprising
a conductive member that connects electrode terminals of the secondary batteries adjacent to each other, wherein
the conductive member has an extension part that extends and contracts in the first direction.

5. The power storage device according to claim 1, further comprising
a conductive member for a power source for connecting a power source to a plurality of the secondary batteries individually, or a plurality of the secondary batteries on a per predetermined block basis, wherein
the conductive member for a power source has a movable part with respect to the first direction.

6. The power storage device according to claim 1, further comprising
a pressure sensor that detects pressure acting on the secondary batteries in the first direction, wherein
at least one of first control of adjusting pressure applied by the pressurizing unit, and second control of outputting information for changing a charging and discharging condition of the secondary batteries is performed on the basis of detection information of the pressure sensor.

7. The power storage device according to claim 1, further comprising
a displacement sensor that detects thickness change in the first direction of the secondary batteries, wherein
at least one of first control of adjusting pressure applied by the pressurizing unit, and second control of outputting information for changing a charging and discharging condition of the secondary batteries is performed on the basis of detection information of the displacement sensor.
